(19) United States
(12) Patent Application Publication
(10) Pub. No.: US 2008/0015870 A1
(43) Pub. Date: Jan. 17, 2008

(54) Apparatus and method for facilitating a search for gems

(76) Inventors: Lawrence Benjamin Elowitz, Seattle, WA (US); Alexander W. Berg, Seattle, WA (US)

Correspondence Address: PERKINS COIE LLP;PATENT-SEA, P.O. BOX 1247, SEATTLE, WA, 98111-1247, US

(21) Appl. No.: 10/452,789

(22) Filed: May 30, 2003

(51) Int. Cl. G06Q 10/00; G06Q 30/00

(52) U.S. Cl. 705/1

(57) ABSTRACT

Apparatus and method for facilitating a search for gems are described. In one embodiment, a computer-readable medium includes instructions to provide a sliding display element for a gem attribute. The sliding display element includes a bar and a slider. The bar represents a nonlinear scale of values of the gem attribute. The slider is configured to be disposed at one of a plurality of positions with respect to the bar. The slider is disposed at a first position with respect to the bar, and the first position is associated with a first value of the gem attribute. The computer-readable medium also includes instructions to identify a first plurality of gems associated with the first value.

### BRIEF DESCRIPTION OF THE INVENTION

The invention relates generally to gems. More particularly, the invention relates to facilitating a search for gems to be included in various jewelry items.

### BACKGROUND OF THE INVENTION

The Internet is a large collection of computers operated using a client-server computer network model. In a client-server computer network, a client computer requests information from a server computer. In response, the server computer provides the requested information to the client computer. In some instances, the server computer can be operated as a web site and can provide the requested information in the form of web pages. Server computers are often operated by large organizations, such as commercial organizations, governmental units, and educational organizations, while client computers are often operated by individuals.

With the increasing popularity of the Internet, commercial organizations have attempted to set up web sites for marketing and selling products and services. By accessing such web sites, consumers can view information regarding various products and services and place purchase orders for particular products and services.

To exploit the capabilities and wide reach of the Internet, it is desirable to set up a web site for marketing and selling gems. A gem refers to a precious or semi-precious material that can be used for ornamental purposes. In some instances, a gem can be cut and polished into a desired shape. Examples of gems include diamonds, pearls, rubies, sapphires, and so forth. A gem can be purchased as a stand-alone item or along with a gem setting in a jewelry item. A gem setting refers to a structure that supports a gem in a jewelry item. Examples of gem settings include chains, ring bands, earring bands, and so forth.

Previous attempts to market and sell products and services using the Internet have often been unsuccessful. While this lack of success has resulted from a number of factors, difficulty of use and lack of interactivity of a web site were sometimes key factors. In the case of marketing and selling gems, web site features that enhance consumer experience can be particularly important, since consumers can be particularly selective when purchasing gems. In particular, web site features that facilitate a search for gems using adjustable and finely tunable search criteria are desirable. In addition, web site features that enhance interactivity based on adjusting search criteria are desirable.

It is against this background that a need arose to develop the apparatus and method described herein.

### SUMMARY OF THE INVENTION

In one innovative aspect, the invention relates to a computer-readable medium. In one embodiment, the computer-readable medium includes a gem search module to facilitate a search for a gem of a jewelry item. The gem search module is configured to provide a first user-interface element. The first user-interface element represents a nonlinear scale of values of a gem attribute. The gem search module is configured to receive a selection of a first value from the nonlinear scale of values and to identify the gem as being associated with the first value. The computer-readable medium also includes a gem setting search module to facilitate a search for a gem setting of the jewelry item. The gem setting search module is configured to provide a second user-interface element. The second user-interface element represents a plurality of values of the gem setting attribute. The gem setting search module is configured to receive a selection of a second value from the plurality of values and to identify the gem setting as being associated with the second value.

In another embodiment, the computer-readable medium includes instructions to provide a sliding display element for a gem attribute. The sliding display element includes a bar and a slider. The bar represents a nonlinear scale of values of the gem attribute. The slider is configured to be disposed at one of a plurality of positions with respect to the bar. The slider is disposed at a first position with respect to the bar, and the first position is associated with a first value of the gem attribute. The computer-readable medium also includes instructions to identify a first plurality of gems associated with the first value.

In another innovative aspect, the invention relates to a computer-implemented method of facilitating a search for gems. In one embodiment, the method includes providing a sliding display element for a gem attribute. The sliding display element includes a bar and a slider. The bar represents a nonlinear scale of values of the gem attribute. The slider is disposed at a first position with respect to the bar, and the first position is associated with a first range of values of the gem attribute. The method also includes indicating a first plurality of gems associated with the first range of values. The method further includes, in response to a request to move the slider, indicating the slider disposed at a second position with respect to the bar. The second position is associated with a second range of values of the gem attribute. In addition, the method includes indicating a second plurality of gems associated with the second range of values.

### BRIEF DESCRIPTION OF THE DRAWINGS

For a better understanding of the nature and objects of the invention, reference should be made to the following detailed description taken in conjunction with the accompanying drawings, in which:

FIG. 1 shows a computer network that can be operated in accordance with an embodiment of the invention.

FIG. 2 shows a flow chart for facilitating a search for gems in accordance with another embodiment of the invention.

FIG. 3 shows an example of a sliding display element that can be provided by a gem search module, according to an embodiment of the invention.

FIG. 4 shows the sliding display element of FIG. 3 in which its sliders are displaced relative to their original positions, according to an embodiment of the invention.

FIG. 5 shows an example of a user-interface screen that can be provided by a gem search module, according to an embodiment of the invention.

FIG. 6 shows another example of a user-interface screen that can be provided by a gem search module, according to an embodiment of the invention.

FIG. 7 shows a further example of a user-interface screen that can be provided by a gem search module, according to an embodiment of the invention.

FIG. 8 shows yet a further example of a user-interface screen that can be provided by a gem search module, according to an embodiment of the invention.

FIG. 9 shows an example of a user-interface screen that can be provided by a gem setting search module, according to an embodiment of the invention.

FIG. 10 shows another example of a user-interface screen that can be provided by a gem setting search module, according to an embodiment of the invention.

FIG. 11 shows a further example of a user-interface screen that can be provided by a gem setting search module, according to an embodiment of the invention.

FIG. 12 shows an example of a user-interface screen that can be provided by a purchase order module, according to an embodiment of the invention.

### DETAILED DESCRIPTION

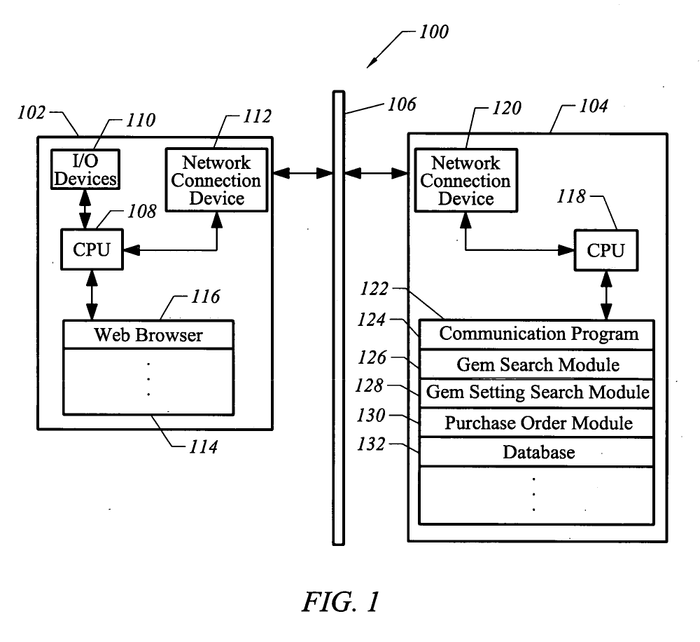

FIG. 1 shows a computer network 100 that can be operated in accordance with an embodiment of the invention. In the illustrated embodiment, the computer network 100 is a client-server computer network that includes at least one client computer 102 and at least one server computer 104. The client computer 102 and the server computer 104 are connected by a transmission channel 106, which can be any wire or wireless transmission channel.

The client computer 102 includes conventional client computer components, including a Central Processing Unit (“CPU”) 108 that is connected to a set of input/output devices 110 (e.g., keyboard, mouse, video monitor, printer, speaker, and so forth), a network connection device 112, and a memory 114. The memory 114 stores a number of computer programs, including a web browser 116. The web browser 116 is configured to establish conventional network communications with the server computer 104 via the network connection device 1 12. In addition, the web browser 116 is configured to visually present information received from the server computer 104. In the illustrated embodiment, the client computer 102 can be operated by a user who desires to obtain information regarding various gems and gem settings. Based on such information, the user may desire to purchase a jewelry item that includes a particular gem and a particular gem setting. In some instances, the user may desire to purchase a particular gem or gem setting as a stand-alone item.

The server computer 104 includes conventional server computer components, including a CPU 118 that is connected to a network connection device 120 and a memory 122. The memory 122 stores a number of computer programs, including a communication program 124. The communication program 124 is configured to establish conventional network communications with the client computer 102 via the network connection device 120.

In the illustrated embodiment, the memory 122 also stores a set of computer programs that implement the processing operations described herein. In particular, the memory 122 stores a gem search module 126, a gem setting search module 128, and a purchase order module 130. As further described below, the various modules 126, 128, and 130 can operate to facilitate a search for gems and gem settings as well as to facilitate purchase of a jewelry item that includes a particular gem and a particular gem setting. Referring to FIG. 1, the various modules 126, 128, and 130 can operate in conjunction with a database 132, which can organize information associated with various gems, gem settings, and jewelry items. In addition, the database 132 can organize sales information provided in connection with various purchase orders. The database 132 can be implemented as, for example, a relational database in which information can be organized using a set of tables.

With reference to FIG. 1, the gem search module 126 is configured to facilitate a search for gems. In particular, the gem search module 126 is used to search for a gem to be included in a jewelry item. For instance, the gem search module 126 can be used to search for a diamond to be included in a bracelet, a brooch, an earring, a pendant, a ring, or any other ornamental object. In some instances, the gem search module 126 can be used to search for a gem to be purchased as a stand-alone item, such as, for example, a loose diamond.

In the illustrated embodiment, the gem search module 126 is configured to provide a first set of user-interface elements to facilitate a search for gems. Examples of user-interface elements include check boxes, icons, numeric or text entry fields, pop-up lists or menus, pull-down lists or menus, push buttons, radio buttons, sliding display elements, scrolling lists, spin boxes, and so forth. The gem search module 126 provides the first set of user-interface elements to the client computer 102, which visually presents the first set of user-interface elements using the web browser 116. Each user-interface element of the first set of user-interface elements can be associated with a different gem attribute. A gem attribute refers to a particular property of a gem, and a value of the gem attribute refers to a particular instance of the gem attribute. Examples of gem attributes include carat weight, clarity, color, cut, length-to-width ratio, polish, price, shape, symmetry, and so forth. Desirably, the gem search module 126 employs gem attributes that are intuitively meaningful to the user to facilitate a search for gems. In some instances, the gem search module 126 can provide tutorials to enhance user understanding of various gem attributes.

To facilitate a search for gems, at least one user-interface element of the first set of user-interface elements represents a nonlinear scale of values of a gem attribute. For instance, the first set of user-interface elements can include a sliding display element that represents a nonlinear scale of values of a gem attribute. A nonlinear scale of values refers to an arrangement of values, such that various intervals in the arrangement of values can be associated with varying differences in values. In some instances, a nonlinear scale of values can be envisioned as an axis of values in which a set of marks are placed at regularly spaced intervals along the axis and in which various intervals along the axis can be associated with varying differences in values. An example of a nonlinear scale of values is a logarithmic scale of values. Unlike a linear scale of values, a nonlinear scale of values of a gem attribute can be tailored to allow a greater or lesser variation of values of the gem attribute at various intervals in the nonlinear scale of values. For instance, the nonlinear scale of values can be tailored to provide a greater or lesser variation of values of the gem attribute at a particular interval based on availability of gems at that interval. Moreover, compared with a linear scale of values, a nonlinear scale of values of a gem attribute can allow a more compact representation of a range of values of the gem attribute. Such compact representation may be particularly desirable for gem attributes that can take on a wide range of values. For instance, a nonlinear scale of values can be particularly desirable for gem attributes such as carat weight and price.

Using the first set of user-interface elements, a set of values of various gem attributes can be specified by the user. The gem search module 126 is configured to receive a user specification of the set of values and to identify one or more gems associated with the set of values. For instance, the gem search module 126 can receive a user selection of a particular value or a particular range of values from a nonlinear scale of values of a gem attribute and can identify a set of gems having the selected value or range of values of the gem attribute. In the illustrated embodiment, the gem search module 126 can perform a search of the database 132 to identify the set of gems. Once the set of gems is identified, the gem search module 126 can indicate the set of gems and can allow the user to select a particular gem to be purchased.

Referring to FIG. 1, the gem setting search module 128 is configured to facilitate a search for gem settings. In particular, the gem setting search module 128 is used to search for a gem setting to be included in a jewelry item. For instance once a diamond has been selected, the gem setting search module 128 can be used to search for a diamond setting to be included with the diamond in a bracelet, a brooch, an earring, a pendant, a ring, or any other ornamental object. In some instances, the gem setting search module 128 can be used to search for a gem setting to be purchased as a stand-alone item.

In the illustrated embodiment, the gem setting search module 128 is configured to provide a second set of user-interface elements to facilitate a search for gem settings. The gem setting search module 128 provides the second set of user-interface elements to the client computer 102, which visually presents the second set of user-interface elements using the web browser 116. Each user-interface element of the second set of user-interface elements can be associated with a different gem setting attribute. A gem setting attribute refers to a particular property of a gem setting, and a value of the gem setting attribute refers to a particular instance of the gem setting attribute. Examples of gem setting attributes include chain length, metal type, price, ring size, and setting style. Desirably, the gem setting search module 128 employs gem setting attributes that are intuitively meaningful to the user to facilitate a search for gem settings. In some instances, the gem setting search module 128 can provide tutorials to enhance user understanding of various gem setting attributes.

Using the second set of user-interface elements, a set of values of various gem setting attributes can be specified by the user. The gem setting search module 128 is configured to receive a user specification of the set of values and to identify one or more gem settings associated with the set of values. For instance, the gem setting search module 128 can provide a user-interface element that represents a number of values of a gem setting attribute. The gem setting search module 128 can receive a user selection of a particular value or a particular range of values of the gem setting attribute and can identify a set of gem settings having the selected value or range of values of the gem setting attribute. In some instances, the gem setting search module 128 can identify the set of gem settings based on whether one or more gem settings of the set of gem settings match a gem that has been selected by the user. In the illustrated embodiment, the gem setting search module 128 can perform a search of the database 132 to identify the set of gem settings. Once the set of gem settings is identified, the gem setting search module 128 can indicate the set of gem settings and can allow the user to select a particular gem setting to be purchased.

The purchase order module 130 is configured to facilitate purchase of jewelry items. In particular, the purchase order module 130 is used to purchase a jewelry item that includes a gem and a gem setting that have been selected by the user. For instance, once a particular diamond and a particular chain have been selected, the purchase order module 130 can be used to purchase a pendant that includes the selected diamond and the selected chain. In some instances, the purchase order module 130 can be used to purchase a gem or a gem setting as a stand-alone item.

In the illustrated embodiment, the purchase order module 130 is configured to provide a third set of user-interface elements to facilitate purchase of a jewelry item. The purchase order module 130 provides the third set of user-interface elements to the client computer 102, which visually presents the third set of user-interface elements using the web browser 116. The third set of user-interface elements can be used to specify various types of sales information, such as, for example, customer name, customer address, method of payment, credit card number, items to be purchased, quantity of items to be purchased, and so forth. Based on such sales information, the purchase order module 130 can identify and process a purchase order of the jewelry item. In the illustrated embodiment, the purchase order module 130 can incorporate the sales information in the database 132 in connection with processing of the purchase order.

While the various modules 126, 128, and 130 and the database 132 are shown residing in the server computer 104, it should be recognized that such configuration is not required in all applications. For instance, one or more of the various modules 126, 128, and 130 or the database 132 may reside in a separate server computer (not shown in FIG. 1) that is connected to the server computer 104. Also, one or more of the various modules 126, 128, and 130 or the database 132 may reside in the client computer 102. For instance, one or more of the various modules 126, 128, and 130 or the database 132 may be downloaded to the client computer 102 in an encrypted or compressed format. In addition, while not shown in FIG. 1, a database management program may be provided to create the database 132 as well as to facilitate access to the database 132.

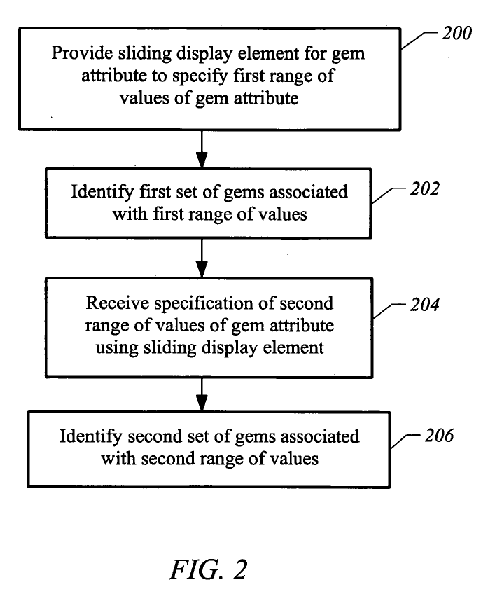

The foregoing discussion provides a general overview of an embodiment of the invention. Attention next turns to FIG. 2 that shows a flow chart for facilitating a search for gems in accordance with another embodiment of the invention.

The first processing operation shown in FIG. 2 is to provide a sliding display element for a gem attribute (block 200). In particular, a gem search module (e.g., the gem search module 126) provides the sliding display element to facilitate a search for gems, which can be purchased as stand-alone items or along with gem settings in jewelry items. In the illustrated embodiment, the sliding display element represents a nonlinear scale of values of the gem attribute and can be used to specify a first range of values included in the nonlinear scale of values.

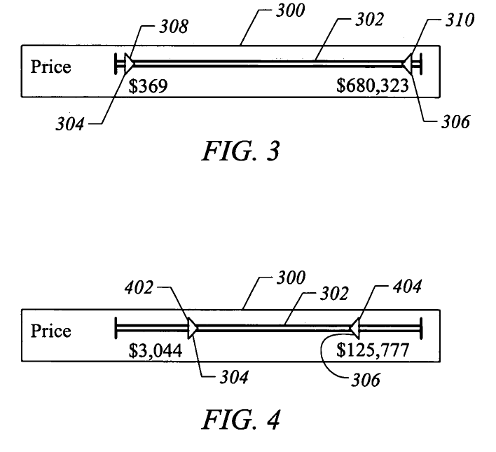

FIG. 3 shows an example of a sliding display element 300 that can be provided by the gem search module. As shown in FIG. 3, the sliding display element 300 includes a bar 302 and a pair of sliders 304 and 306. The bar 302 represents a nonlinear scale of values of a gem attribute, which, in the present example, corresponds to price. The sliders 304 and 306 cooperatively serve to specify a range of values included in the nonlinear scale of values. In particular, the slider 304 is configured to be disposed at one of various positions with respect to the bar 302 to specify a lower limit of the gem attribute. As shown in FIG. 3, the slider 304 is disposed at position 308 with respect to the bar 302, which position 308 is associated with a particular lower limit of the gem attribute (i.e., a lower price limit of $369). The slider 306 is configured to be disposed at one of various positions with respect to the bar 302 to specify an upper limit of the gem attribute. As shown in FIG. 3, the slider 306 is disposed at position 310 with respect to the bar 302, which position 310 is associated with a particular upper limit of the gem attribute (i.e., an upper price limit of $680,323).

In the present example, the nonlinear scale of values can be tailored to allow a greater or lesser variation of values of the gem attribute as the slider 304 or 306 is displaced relative to the bar 302. Advantageously, use of the nonlinear scale of the values allows one or more “sweet spots” to be created along the bar 302. The “sweet spots” can correspond to portions of the bar 302 associated with a lesser variation of values of the gem attribute or a greater availability of gems having values associated with the “sweet spots.” By allowing varying sensitivity to displacement of the slider 304 or 306 depending on availability of gems, use of the nonlinear scale of values facilitates fine tuning of a search for gems based on displacement of the slider 304 or 306. Use of the nonlinear scale of values also allows a more compact representation of the relatively wide range of values of the gem attribute (i.e., $369 to $680,323).

Turning back to FIG. 2, the second processing operation shown is to identify a first set of gems associated with the first range of values of the gem attribute (block 202). In particular, the gem search module produces a first search query based on the first range of values and identifies the first set of gems as responsive to the first search query. With reference to the example shown in FIG. 3, the gem search module can identify the first set of gems as having prices within the specified price range of $369 to $680,323. As discussed previously, the gem search module can perform a search of a database (e.g., the database 132) to identify the first set of gems.

Once the first set of gems is identified, the gem search module can indicate the first set of gems and can allow the user to select a particular gem to be purchased. In some instances, the gem search module can provide information regarding a particular gem to allow the user to make an educated purchase of the gem. For instance, in response to a user selection of a gem from the first set of gems, the gem search module can indicate values of various gem attributes for the selected gem. Advantageously, the gem search module can also provide information regarding various gems to allow a comparison of the gems. For instance, in response to a user selection of various gems from the first set of gems, the gem search module can indicate respective values of various gem attributes for the selected gems. In the illustrated embodiment, the gem search module can also allow fine tuning of a search for gems as described below.

As shown in FIG. 2, the third processing operation is to receive a user specification of a second range of values of the gem attribute (block 204). In particular, the gem search module receives a user specification of the second range of values included in the nonlinear scale of values.

Referring to FIG. 4, the sliding display element 300, which was previously discussed in connection with FIG. 3, is shown with the sliders 304 and 306 displaced relative to their original positions and specifying a different range of values of the gem attribute. In particular, in response to a user request to move the slider 304, the slider 304 is indicated as being disposed at position 402 with respect to the bar 302, which position 402 is associated with a different lower limit of the gem attribute (i.e., a lower price limit of $3,044). Also, in response to a user request to move the slider 306, the slider 306 is indicated as being disposed at position 404 with respect to the bar 302, which position 404 is associated with a different upper limit of the gem attribute (i.e., an upper price limit of $125,777). While both sliders 304 and 306 are shown displaced relative to their original positions, it should be recognized that either, or both, of the sliders 304 and 306 can be displaced to specify various ranges of values of the gem attribute.

The fourth processing operation shown in FIG. 2 is to identify a second set of gems associated with the second range of values of the gem attribute (block 206). In particular, the gem search module produces a second search query based on the second range of values and identifies the second set of gems as responsive to the second search query. With reference to the example shown in FIG. 4, the gem search module can identify the second set of gems as having prices within the specified price range of $3,044 to $125,777. As discussed previously, the gem search module can perform a search of a database (e.g., the database 132) to identify the second set of gems.

Once the second set of gems is identified, the gem search module can indicate the second set of gems and can allow the user to select a particular gem to be purchased. As discussed previously, the gem search module can provide information regarding various gems to allow a comparison of the gems and to allow the user to make an educated purchase of a particular gem. If desired, further fine tuning of a search for gems can be performed in a similar manner as described above.

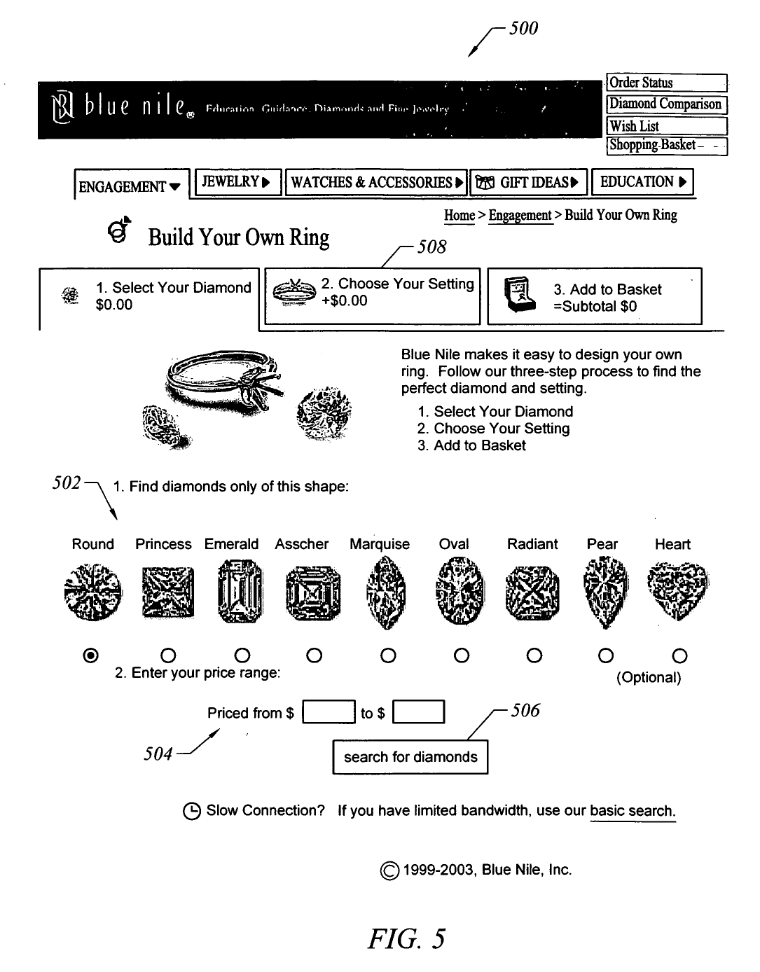

FIG. 5 through FIG. 12 show examples of user-interface screens that can be provided according to an embodiment of the invention. In particular, FIG. 5 through FIG. 12 show a sequence of user-interface screens to facilitate a search for a diamond and a ring band and to facilitate purchase of a ring that includes the diamond and the ring band. In the illustrated embodiment, the various user-interface screens can be provided as web pages that are visually presented to a user using a web browser (e.g., the web browser 116).

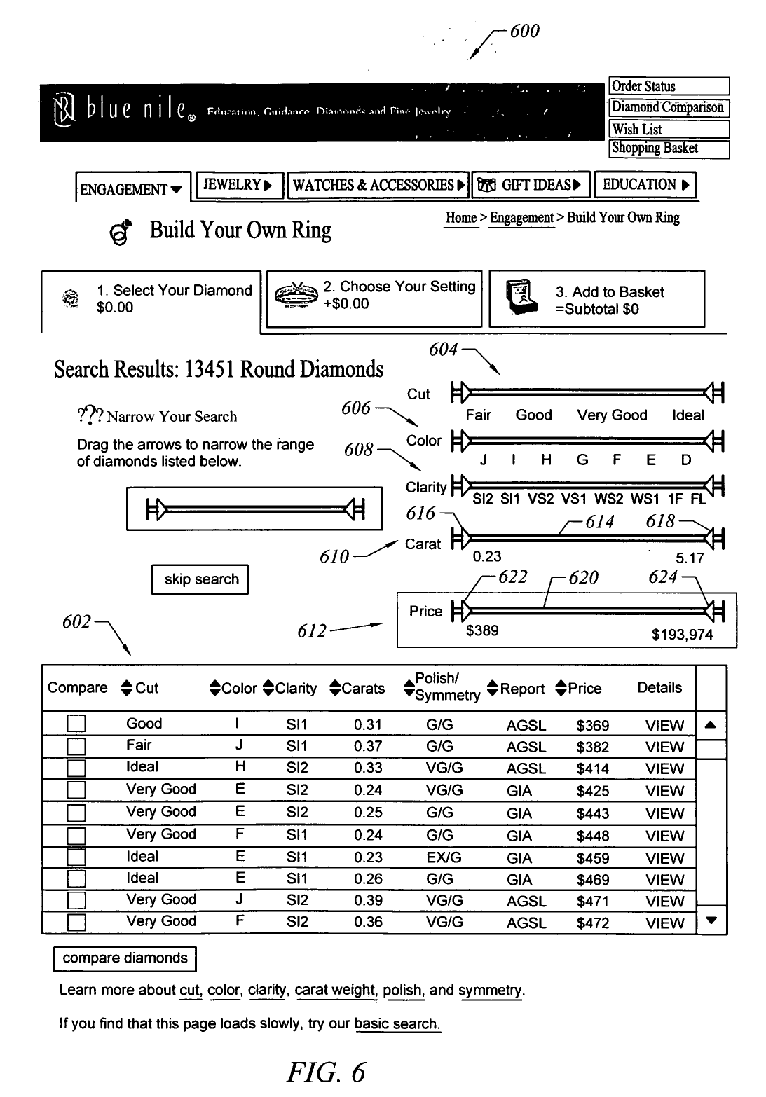

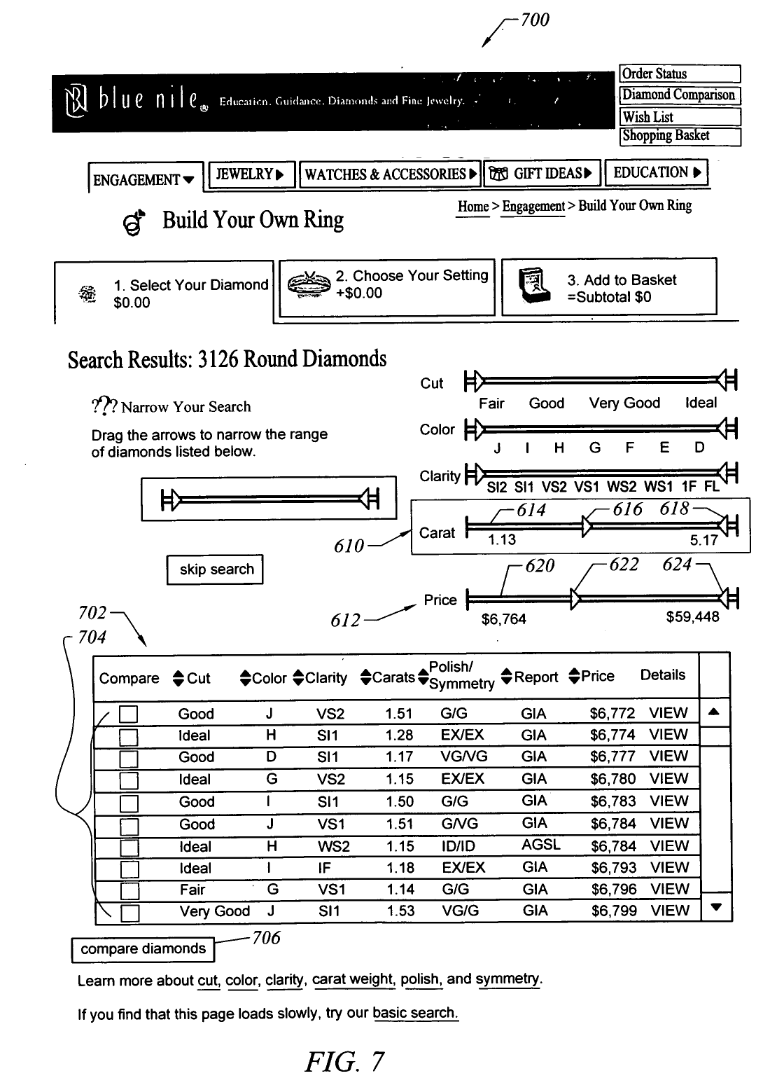

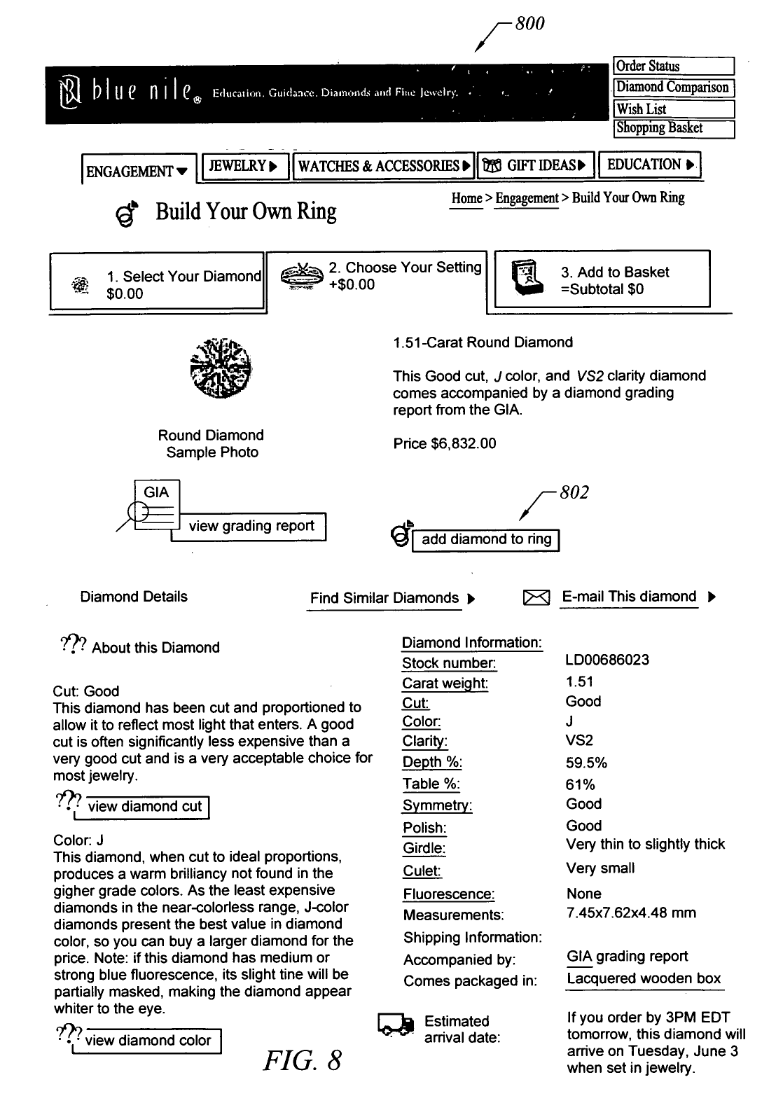

FIG. 5, FIG. 6, FIG. 7, and FIG. 8 show examples of user-interface screens that can be provided by a gem search module (e.g., the gem search module 126). In particular, FIG. 5 shows a user-interface screen 500 to facilitate a search for a diamond to be included in a ring. As shown in FIG. 5, the user-interface screen 500 includes user-interface elements 502 and 504. The user-interface element 502 is provided as a set of radio buttons that allow the user to specify a particular shape of a diamond, such as, for example, round, princess, emerald, asscher, marquise, oval, radiant, pear, or heart. The user-interface element 504 is provided as a set of numeric entry fields that allow the user to specify a lower price limit and an upper price limit of a diamond. In the present example, a round shape is specified by, for example, a mouse click or a keyboard selection, and an option 506 labeled as “search for diamonds” is selected to search for diamonds having a round shape. As shown in FIG. 5, the user-interface screen 500 includes a status portion 508 that serves to indicate status information.

FIG. 6 shows a user-interface screen 600 indicating a set of diamonds that is identified. In the present example, 13,451 diamonds are identified as having a round shape. As shown in FIG. 6, various identified diamonds are indicated in a search results portion 602 of the user-interface screen 600. In the present example, the search results portion 602 also indicates respective values of various gems attributes for the identified diamonds.

As shown in FIG. 6, the user-interface screen 600 includes user-interface elements 604, 606, 608, 610, and 612, which can be used to fine tune a search for diamonds. The user-interface element 604 allows the user to specify a range of values of the cut of a diamond. The cut of a diamond refers to the quality of processing that is used to shape the diamond and can be measured based on the diamond's roundness, depth, width, and uniformity of its facets. As shown in FIG. 6, the cut of a diamond can take on values that range from, for example, fair cut to ideal cut. The user-interface element 606 allows the user to specify a range of values of the color of a diamond. The color of a diamond refers to the ability of the diamond to reflect light of various wavelengths and can take on values that range from, for example, J (i.e., color slightly detectable) to D (i.e., no traces of color detectable by an expert gemologist). The user-interface element 608 allows the user to specify a range of values of the clarity of a diamond. The clarity of a diamond refers to the amount of trace minerals, fractures, or other imperfections present in the diamond and can take on values that range from, for example, S12 (i.e., imperfections detectable under 10 times magnification and slightly detectable to unaided eye) to FL (i.e., no imperfections detectable under 10 times magnification). The user-interface element 610 allows the user to specify a range of values of the carat weight of a diamond, such as, for example, a range of values within 0.23 and 5.17 carats. And, the user-interface element 612 allows the user to specify a price range, such as, for example, a price range within $369 and $193,974.

In the present example, each of the user-interface elements 604, 606, 608, 610, and 612 is provided as a sliding display element that includes a bar and a pair of sliders. Each pair of sliders can be independently displaced to fine tune a search for diamonds. As shown in FIG. 6, the user-interface elements 604, 606, and 608 represent linear scales of values of the cut, color, and clarity of a diamond, respectively. The user-interface element 610 includes a bar 614, which represents a nonlinear scale of values of the carat weight of a diamond, and a pair of sliders 616 and 618. Either, or both, of the sliders 616 and 618 can be displaced by, for example, a click and drag operation to specify various ranges of values included in the nonlinear scale of values of the carat weight of a diamond. The user-interface element 612 includes a bar 620, which represents a nonlinear scale of values of the price of a diamond, and a pair of sliders 622 and 624. Either, or both, of the sliders 622 and 624 can be displaced to specify various ranges of values included in the nonlinear scale of values of the price of a diamond.

Turning next to FIG. 7, a user-interface screen 700 is shown in which the sliders 616, 622, and 624 are displaced relative to their original positions shown in FIG. 6. As shown in FIG. 7, the slider 616 is displaced relative to the bar 614 to specify a lower carat weight limit of 1.13 carats. Also, the sliders 622 and 624 are displaced relative to the bar 620 to specify a lower price limit of $6,764 and an upper price limit of $59,448. In connection with the displacement of the sliders 616, 622, and 624, a different set of diamonds having a round shape and having the specified ranges of carat weight and price is automatically identified. This different set of diamonds can form a subset of the previously identified set of diamonds. In the present example, 3,126 diamonds are identified, and various identified diamonds are indicated in a search results portion 702 of the user-interface screen 700. Advantageously, the user-interface screen 700 provides enhanced interactivity by allowing the user to quickly see the impact that the displacement of the sliders 616, 622, and 624 has on price and availability of diamonds. Moreover, such enhanced interactivity allows the user to easily make trade-offs in various gem attributes to locate a desired diamond.

As shown in FIG. 7, the user-interface screen 700 also includes a set of check boxes 704 that allow the user to select two or more diamonds for comparison purposes. Once two or more diamonds have been selected, an option 706 labeled as “compare diamonds” can be selected, and respective values of various diamond attributes for the selected diamonds can be indicated. Based on a comparison of two or more diamonds, the user can select a particular diamond to be included in the ring. FIG. 8 shows a user-interface screen 800 to facilitate a selection of a diamond to be included in the ring. In the present example, a 1.51-carat round diamond is selected using an option 802 labeled as “add diamond to ring.”

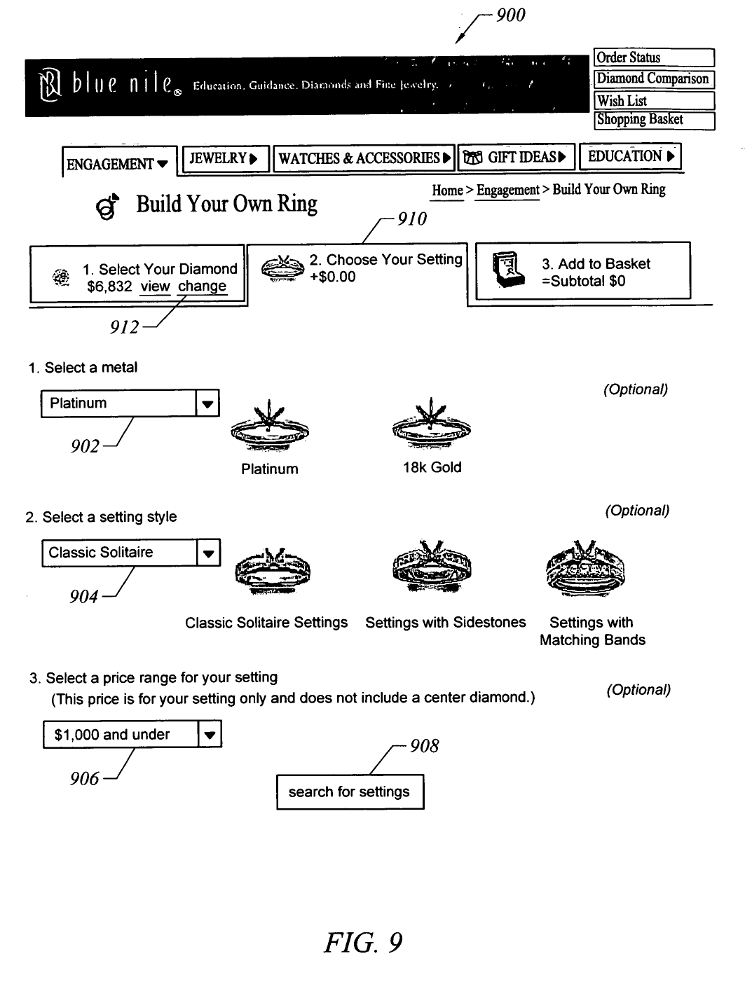

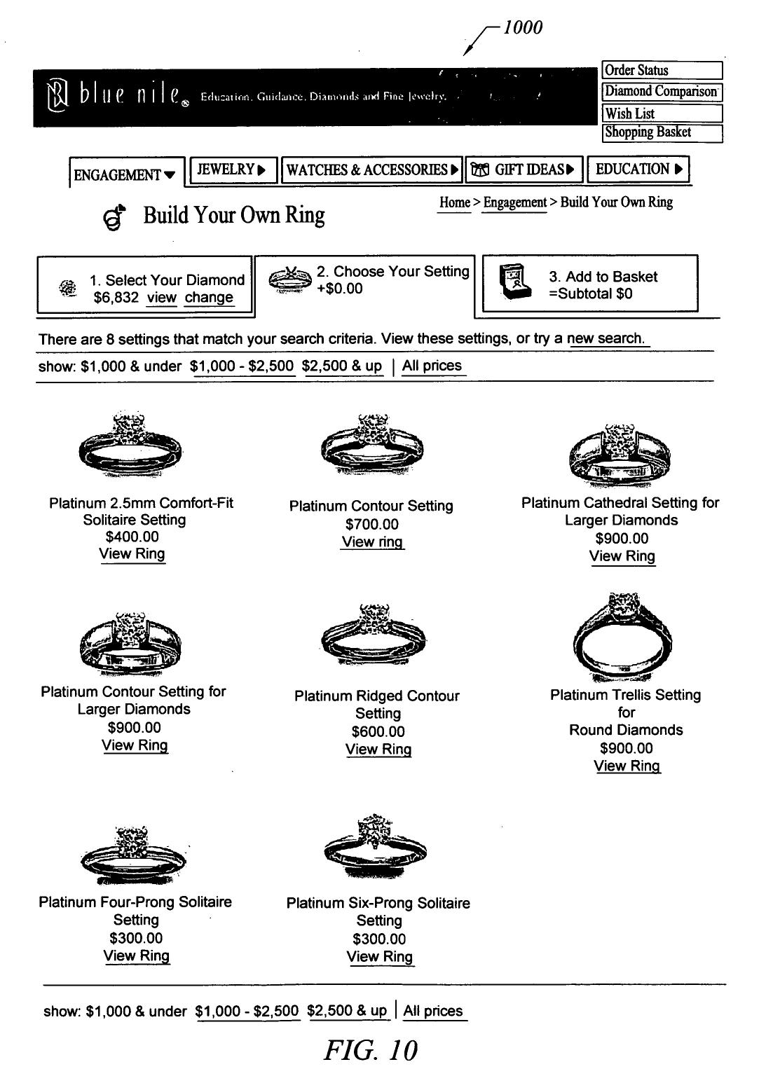

Turning next to FIG. 9, FIG. 10, and FIG. 1, various examples of user-interface screens that can be provided by a gem setting search module (e.g., the gem setting search module 128) are shown. FIG. 9 shows a user-interface screen 900 to facilitate a search for a ring band to be included in a ring. As shown in FIG. 9, the user-interface screen 900 includes user-interface elements 902, 904, and 906, each of which is provided as a pull-down menu. The user-interface element 902 allows the user to specify a metal type for a ring band, such as, for example, platinum or gold. The user-interface element 904 allows the user to specify a setting style, such as, for example, a classic solitaire setting, a setting with sidestones, or a setting with matching band. The user-interface element 906 allows the user to specify a price range for a ring band. In the present example, a platinum metal type, a classic solitaire setting, and a price range of $1,000 and under are specified, and an option 908 labeled as “search for settings” is selected to search for ring bands having these specified values. As shown in FIG. 9, the user-interface screen 900 includes a status portion 910 that indicates updated status information to reflect a previously selected diamond. The status portion 910 includes an option 912 labeled as “change,” which can be selected to search for a different diamond to be included in the ring.

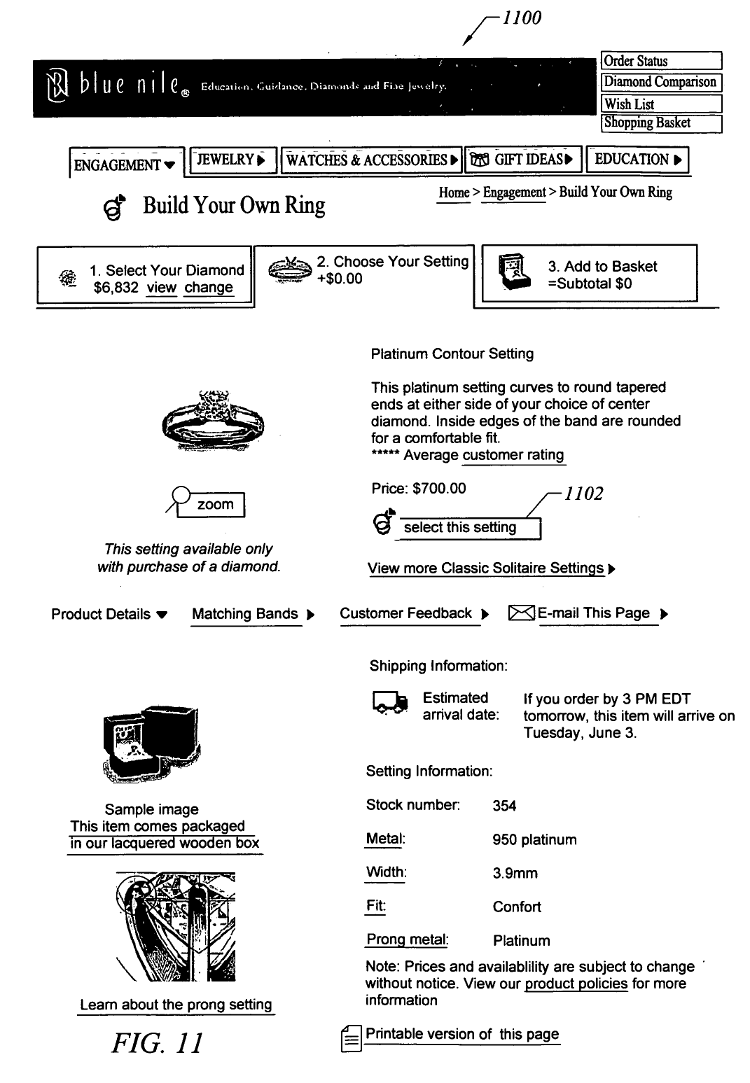

Referring next to FIG. 10, a user-interface screen 1000 is shown that indicates a set of ring bands that is identified. In the present example, the user-interface screen 1000 indicates that eight ring bands are identified and provides a visual representation of each identified ring band along with the previously selected diamond. Based on a comparison of two or more ring bands, the user can select a particular ring band to be included in the ring. FIG. 11 shows a user-interface screen 1100 to facilitate a selection of a ring band to be included in the ring. In the present example, a platinum contour setting is selected using an option 1102 labeled as “select this setting.”

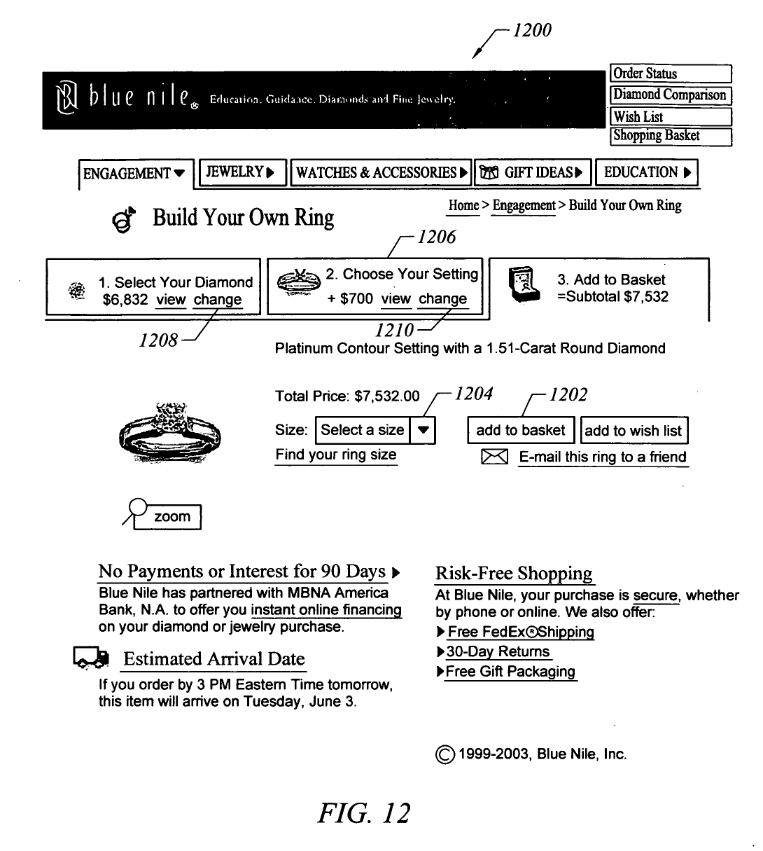

Once a diamond and a ring band have been selected, the user may desire to purchase a ring that includes the selected diamond and ring band. FIG. 12 shows a user-interface screen 1200 that-can be provided by a purchase order module (e.g., the purchase order module 130). In the present example, a purchase order for the ring can be specified using an option 1202 labeled as “add to basket.” As shown in FIG. 12, the user-interface screen 1200 includes an user-interface element 1204, which is provided as a pull-down menu and allows the user to specify a ring size for the ring band. The user-interface screen 1200 also includes a status portion 1206 that indicates updated status information to reflect the selected diamond and ring band. The status portion 1206 includes options 1208 and 1210, which are labeled as “change” and can be selected to search for a different diamond or ring band to be included in the ring.

It should be recognized that the specific embodiments of the invention discussed above are provided by way of example, and various other embodiments are encompassed by the invention.

For instance, while two sliders 304 and 306 are shown included in the sliding display element 300 of FIG. 3, it should be recognized that more or less sliders can be included in some embodiments of the invention. For instance, the sliding display element 300 may include a single slider that is used to specify a particular value or a particular range of values included in the nonlinear scale of values of the gem attribute. Also, while a single bar 302 is shown in FIG. 3, it is contemplated that the sliding display element 300 may include several bars along with one or more sliders.

Also, in some embodiments of the invention, a gem setting search module may provide at least one user-interface element that represents a nonlinear scale of values of a gem setting attribute. For instance, the user-interface element may be provided as a sliding display element that represents a nonlinear scale of values of a gem setting attribute such as chain length, price, or ring size.

An embodiment of the invention may include a help system, including a wizard that provides assistance to users for configuring a computer (e.g., the computer 102 or 104) and its various components.

An embodiment of the invention relates to a computer storage product with a computer-readable medium having computer code thereon for performing various computer-implemented operations. The term “computer-readable medium” is used herein to include any medium that is capable of storing or encoding a sequence of instructions or computer codes for performing the operations described herein. The media and computer code may be those specially designed and constructed for the purposes of the invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher level code that are executed by a computer using an interpreter. For example, an embodiment of the invention may be implemented using Java, C++, or other object-oriented programming language and development tools. Additional examples of computer code include encrypted code and compressed code.

Moreover, an embodiment of the invention may be downloaded as a computer program product, which may be transferred from a remote computer (e.g., a server computer) to a requesting computer (e.g., a client computer or a different server computer) by way of data signals embodied in a carrier wave or other propagation medium via a transmission channel. Accordingly, as used herein, a carrier wave can be regarded as a computer-readable medium.

Another embodiment of the invention may be implemented in hardwired circuitry in place of, or in combination with, machine-executable software instructions.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit, and scope of the invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the invention. Accordingly, unless specifically indicated herein, the order and grouping of the steps is not a limitation of the invention.

What is claimed is:

1. A computer-readable medium comprising:
a gem search module to facilitate a search for a gem of a jewelry item, said gem search module being configured to provide a first user-interface element, said first user-interface element representing a nonlinear scale of values of a gem attribute, said gem search module being configured to receive a selection of a first value from said nonlinear scale of values and to identify said gem as being associated with said first value; and
a gem setting search module to facilitate a search for a gem setting of said jewelry item, said gem setting search module being configured to provide a second user-interface element, said second user-interface element representing a plurality of values of a gem setting attribute, said gem setting search module being configured to receive a selection of a second value from said plurality of values and to identify said gem setting as being associated with said second value.

2. The computer-readable medium of claim 1, wherein said first user-interface element corresponds to a sliding display element, said sliding display element including a bar and a slider, said bar representing said nonlinear scale of values, said slider being configured to be disposed at one of a plurality of positions with respect to said bar, said slider being disposed at a first position with respect to said bar, said first position being associated with said first value.

3. The computer-readable medium of claim 1, wherein said gem attribute corresponds to one of price and carat weight.

4. The computer-readable medium of claim 1, wherein said nonlinear scale of values corresponds to a logarithmic scale of values of said gem attribute.

5. The computer-readable medium of claim 1, wherein said gem setting attribute corresponds to one of chain length, metal type, price, ring size, and setting style.

6. A computer-readable medium comprising:
instructions to provide a sliding display element for a gem attribute, said sliding display element including a bar and a slider, said bar representing a nonlinear scale of values of said gem attribute, said slider being configured to be disposed at one of a plurality of positions with respect to said bar, said slider being disposed at a first position with respect to said bar, said first position being associated with a first value of said gem attribute; and
instructions to identify a first plurality of gems associated with said first value.

7. The computer-readable medium of claim 6, wherein said instructions to identify said first plurality of gems include:
instructions to produce a first search query based on said first value; and
instructions to identify said first plurality of gems as responsive to said first search query.

8. The computer-readable medium of claim 6, wherein said gem attribute corresponds to one of price and carat weight.

9. The computer-readable medium of claim 6, wherein said nonlinear scale of values corresponds to a logarithmic scale of values of said gem attribute.

10. The computer-readable medium of claim 6, further comprising:
instructions to receive a request to move said slider to a second position with respect to said bar, said second position being associated with a second value of said gem attribute; and
instructions to identify a second plurality of gems associated with said second value.

11. The computer-readable medium of claim 10, wherein said instructions to identify said second plurality of gems include:
instructions to produce a second search query based on said second value; and
instructions to identify said second plurality of gems as responsive to said second search query.

12. The computer-readable medium of claim 10, wherein said first value and said second value correspond to a first lower limit and a second lower limit of said gem attribute, respectively.

13. The computer-readable medium of claim 10, wherein said first value and said second value correspond to a first upper limit and a second upper limit of said gem attribute, respectively.

14. A computer-implemented method of facilitating a search for gems, comprising:
providing a sliding display element for a gem attribute, said sliding display element including a bar and a slider, said bar representing a nonlinear scale of values of said gem attribute, said slider being disposed at a first position with respect to said bar, said first position being associated with a first range of values of said gem attribute;
indicating a first plurality of gems associated with said first range of values;
in response to a request to move said slider, indicating said slider disposed at a second position with respect to said bar, said second position being associated with a second range of values of said gem attribute; and
indicating a second plurality of gems associated with said second range of values.

15. The computer-implemented method of claim 14, wherein said second plurality of gems corresponds to a subset of said first plurality of gems.

16. The computer-implemented method of claim 14, wherein said nonlinear scale of values corresponds to a logarithmic scale of values of said gem attribute.

17. The computer-implemented method of claim 14, wherein said slider is configured to be disposed at one of a plurality of positions with respect to said bar to select a lower limit of said gem attribute, said first position being associated with a first lower limit of said first range of values, said second position being associated with a second lower limit of said second range of values.

18. The computer-implemented method of claim 17, wherein said slider corresponds to a first slider, said sliding display element further including a second slider, said second slider being configured to be disposed at one of a plurality of positions with respect to said bar to select an upper limit of said gem attribute, said second slider being disposed at a third position with respect to said bar, said third position being associated with a first upper limit of said first range of values, wherein indicating said first plurality of gems includes indicating said first plurality of gems associated with said first lower limit and said first upper limit.

19. The computer-implemented method of claim 17, further comprising:
in response to a request to move said second slider, indicating said second slider disposed at a fourth position with respect to said bar, said fourth position being associated with a second upper limit of said second range of values,
wherein indicating said second plurality of gems includes indicating said second plurality of gems associated with said second lower limit and said second upper limit.

20. The computer-implemented method of claim 14, further comprising:
receiving a selection of a first gem from said second plurality of gems;
receiving a selection of a second gem from said second plurality of gems; and
indicating a first value of said gem attribute for said first gem and a second value of said gem attribute for said second gem.
